(19) United States
(12) Patent Application Publication
(10) Pub. No.: US 2025/0362473 A1
(43) Pub. Date: Nov. 27, 2025

(54) LENS DRIVING DEVICE

(71) Applicant: AAC Microtech (Changzhou) Co., Ltd., Changzhou City (CN)

(72) Inventors: Bo Xiao, Changzhou (CN); Tong Zhang, Changzhou (CN); Ronglin Linghu, Changzhou (CN); Wei Song, Changzhou (CN)

(21) Appl. No.: 19/008,550

(22) Filed: Jan. 2, 2025

Related U.S. Application Data
(63) Continuation of application No. PCT/CN2024/094862, filed on May 23, 2024.

(51) Int. Cl. G02B 7/02; H02K 41/035

(52) U.S. Cl. CPC G02B 7/023; H02K 41/0356

(57) ABSTRACT

A lens driving device, including a fixation frame, a lens barrel configured to carry a lens assembly having an optical axis, an elastic connection member connecting the fixation frame to the lens barrel, and a driving assembly driving the lens barrel to move along a direction of the optical axis. The driving assembly includes a magnetic circuit system and a coil. The magnetic circuit system includes a magnetic frame and a magnet portion. The magnetic frame includes a top wall and a bottom wall, and a side wall. The magnet portion is between the top wall and the bottom wall. The coil is arranged at a peripheral of the magnet portion. The side wall is provided with two notches, the lens barrel extends toward the coil to form a pair of support arms for clamping the coil. The lens driving device has good driving effect and reduces magnetic interference.

### TECHNICAL FIELD

The present disclosure relates to the technical field of voice coil motors, and in particular, to a lens driving device.

### BACKGROUND

A lens driving device in the related art includes a fixation frame, a lens barrel carrying a lens assembly, and a driving assembly driving the lens barrel to move along a direction of an optical axis of the lens assembly. The driving assembly includes a magnetic circuit system fixed to a side wall of a peripheral straight edge of the fixation frame, and a coil provided at an outer periphery of the lens barrel.

However, since the magnetic circuit system is an open loop, on one hand, magnetic leakage results in low power conversion efficiency, leading to a poor driving effect; and on the other hand, magnetic leakage can also causes magnetic interference to other ferromagnetic components and electronic elements.

In view of this, the present disclosure provides a new lens driving device to solve the above-mentioned technical problems.

### SUMMARY

An object of the present disclosure is to solve the above-mentioned technical problems and provide a lens driving device having a good driving effect and capable of reducing magnetic interference.

In order to achieve the above-mentioned object, an embodiment of the present disclosure provides a lens driving device, including: a fixation frame; a lens barrel received in the fixation frame and configured to carry a lens assembly having an optical axis; an elastic connection member connecting the fixation frame to the lens barrel and supporting the lens barrel to move relative to the fixation frame; and a driving assembly driving the lens barrel to move along a direction of the optical axis. The driving assembly is arranged at a corner of the fixation frame, the driving assembly includes a magnetic circuit system fixed to the fixation frame and a coil fixed to the lens barrel, the magnetic circuit system includes a magnetic frame and a magnet portion received in the magnetic frame, the magnetic frame includes a top wall and a bottom wall opposite to each other along the direction of the optical axis, and a side wall connecting the top wall and the bottom wall, the magnet portion is sandwiched between the top wall and the bottom wall, the coil is received in the magnetic frame and arranged at a peripheral of the magnet portion, the side wall is provided with two notches that are formed at two sides of the coil, the lens barrel extends toward the coil to form a pair of support arms for clamping the coil, and the pair of support arms enter the magnetic frame from the two notches of the side wall to clamp the coil.

As an improvement, the magnet portion includes a first magnet fixed to the top wall, a second magnet fixed to the bottom wall, and a pole core sandwiched between the first magnet and the second magnet; the first magnet and the second magnet are magnetized in the direction of the optical axis; and a magnetizing direction of the first magnet is opposite to a magnetizing direction of the second magnet.

As an improvement, the coil includes a first coil wall and a second coil wall opposite to each other in parallel, and a pair of third coil walls connecting the first coil wall to the second coil wall; the first coil wall is closer to the lens barrel than the second coil wall; a length of an orthographic projection of the first coil wall along the direction of the optical axis is greater than a length of an orthographic projection of the second coil wall along the direction of the optical axis; and the pair of support arms are fixedly connected to the pair of third coil walls.

As an improvement, when viewed from the direction of the optical axis, the coil and the magnet portion have contour shapes matching each other.

As an improvement, two driving assemblies are provided, and the two driving assemblies are arranged at a pair of corners opposite to each other of the fixation frame.

As an improvement, the elastic connection member is made of a polymer material.

As an improvement, the polymer material includes at least one of silica gel, nitrile rubber, ethylene acrylate rubber, acrylate rubber, butyl rubber, polyether-ether-ketone plastic or polyimide plastic.

As an improvement, the elastic connection member includes: a first elastic member that is arranged at a top of the lens barrel and is of a complete annular structure; and four second elastic members that are arranged at a bottom of the lens barrel and correspondingly arranged at four corners of the fixation frame.

As an improvement, the elastic connection member includes a deformation portion having a wave-shaped cross section, a first fixing portion extending from an inner periphery of the deformation portion, and a second fixing portion extending from an outer periphery of the deformation portion; and the first fixing portion is fixed to the lens barrel, and the second fixing portion is fixed to the fixation frame.

In the lens driving device of the embodiments of the present disclosure, the driving assembly is arranged at the corner of the fixation frame. The magnetic frame includes the top wall, the bottom wall and the side wall. The magnet portion is sandwiched between the top wall and the bottom wall, and the coil is arranged at a peripheral of the magnet portion. The lens barrel extends towards the coil to form a pair of support arms for clamping the coil, and the pair of support arms enter the magnetic frame from the two notches of the side wall to clamp the coil. The lens driving device of the embodiments of the present disclosure cleverly configure the position and the structure of the driving assembly, and configure the magnetic frame and the magnet portion to form a closed magnetic circuit system, which can significantly reduce magnetic leakage. On one hand, the power conversion efficiency is improved. When the driving assembly provides a same driving force, a volume of the driving assembly can be smaller, which can provide more design choices for other components; or when the driving assembly has a same volume, the driving assembly can provide a greater driving force, and can improve the driving sensitivity. On the other hand, magnetic interference caused by the driving assembly to other ferromagnetic components and electronic elements can be reduced.

### BRIEF DESCRIPTION OF DRAWINGS

In order to better illustrate the technical solutions of embodiments of the present disclosure, the following describes the drawings required in the embodiments briefly. It is appreciated that, the drawings described below are merely some embodiments of the present disclosure, and for those skilled in the art, other drawings can be obtained based on these drawings without creative efforts.

FIG. 1 is a perspective view of a lens driving device according to an embodiment of the present disclosure;

FIG. 2 is an exploded view of the lens driving device shown in FIG. 1;

FIG. 3 is a schematic diagram of a combined structure of a lens barrel, a coil and a part of a magnetic circuit system of the lens driving device shown in FIG. 1;

FIG. 4 is a perspective view of a driving assembly of the lens driving device shown in FIG. 1;

FIG. 5 is a perspective view of a coil of the lens driving device shown in FIG. 1; and

FIG. 6 is a partial sectional view of an elastic connection member of the lens driving device shown in FIG. 1.

### DESCRIPTION OF EMBODIMENTS

The technical solutions in embodiments of the present disclosure will be described in details below in connection with the drawings in the embodiments of the present disclosure, and it is apparent that the embodiments described herein are merely some of, rather than all of the embodiments of the present disclosure. All other embodiments obtained by those of ordinary skill in the art based on the embodiments of the present disclosure without creative efforts shall fall within a scope of the present disclosure.

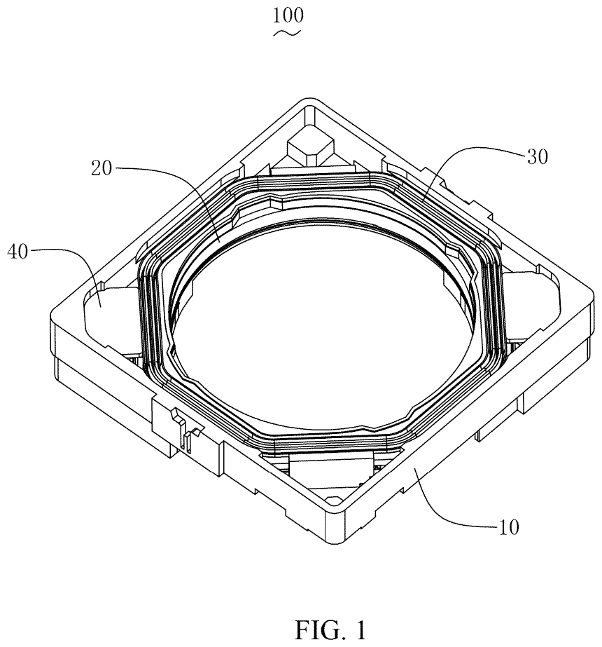

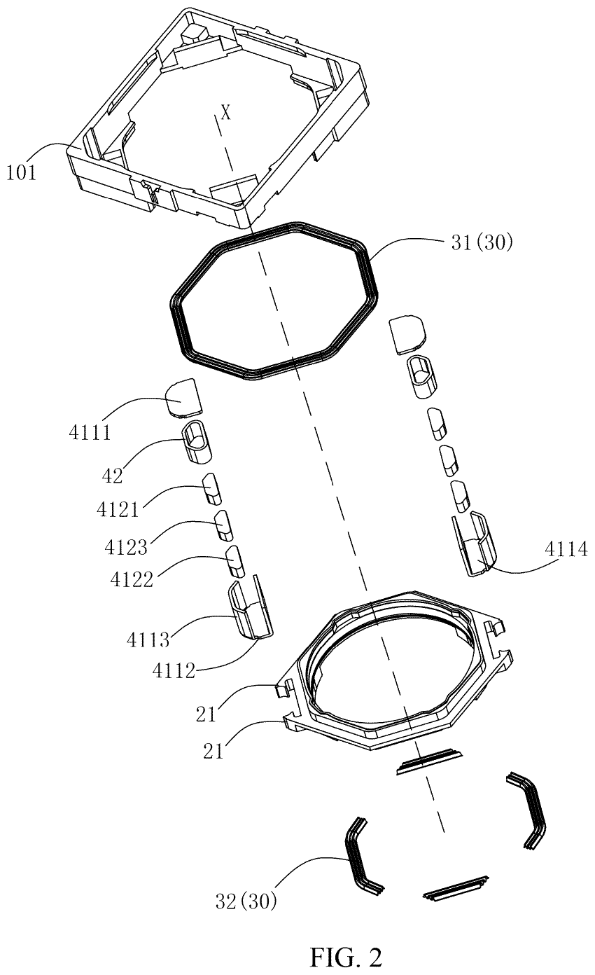

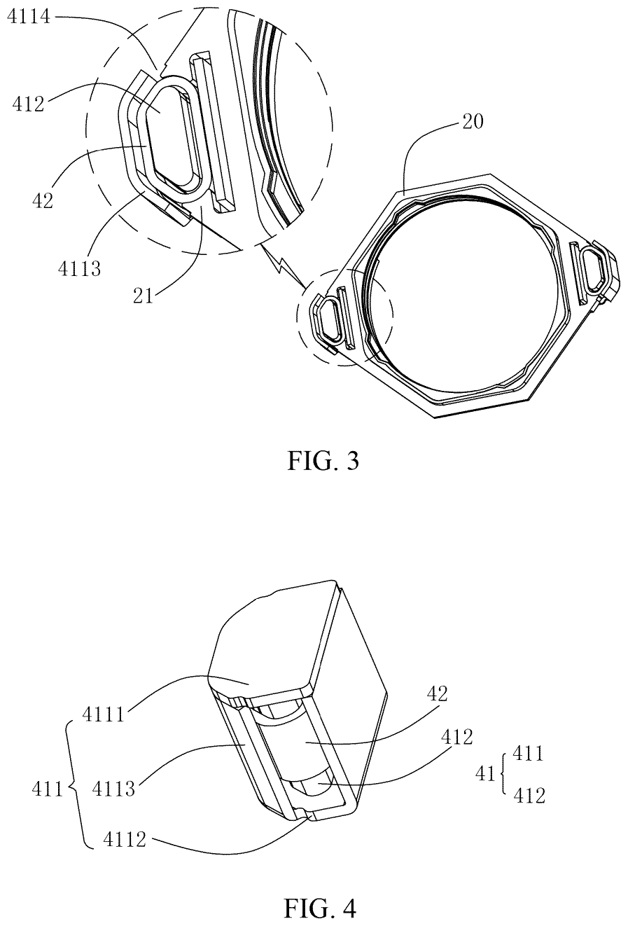

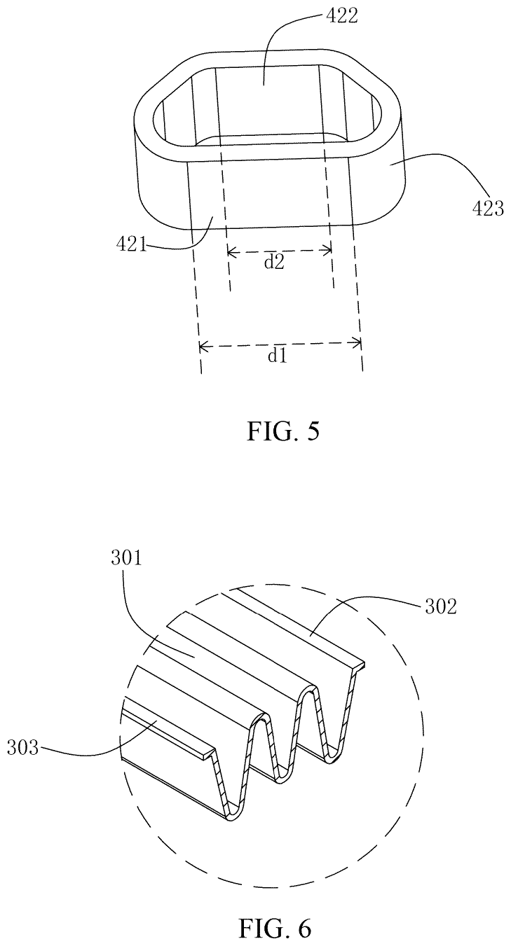

Referring to FIG. 1 to FIG. 6, some embodiments of the present disclosure provide a lens driving device 100, including a fixation frame 10, a lens barrel 20 received in the fixation frame 10 and configured to carry a lens assembly having an optical axis X, an elastic connection member 30 connecting the fixation frame 10 to the lens barrel 20 and supporting the lens barrel 20 to move relative to the fixation frame 10, and a driving assembly 40 driving the lens barrel 20 to move along a direction of the optical axis X.

The driving assembly 40 is arranged at a corner 101 of the fixation frame 10.

In an embodiment of the present disclosure, two driving assemblies 40 are provided, and the two driving assemblies 40 are arranged at a pair of corners 101 opposite to each other of the fixation frame 10, respectively.

The driving assembly 40 includes a magnetic circuit system 41 fixed to the fixation frame 10, and a coil 42 fixed to the lens barrel 20.

The magnetic circuit system 41 includes a magnetic frame 411 and a magnet portion 412 received in the magnetic frame 411.

The magnet frame 411 includes a top wall 4111 and a bottom wall 4112 that are opposite to each other along the direction of the optical axis X, and a side wall 4113 connecting the top wall 4111 to the bottom wall 4112. The magnet portion 412 is sandwiched between the top wall 4111 and the bottom wall 4112, and the coil 42 is received in the magnet frame 411 and arranged at a peripheral of the magnet portion 412.

The side wall 4113 is provided with two notches 4114 at two sides of the coil 42.

The lens barrel 20 extends toward the coil 42 to form a pair of support arms 21 for clamping the coil 42, and the pair of support arms 21 enter the magnetic frame 411 from two notches 4114 of the side wall 4113 to clamp the coil 42.

The magnet portion 412 includes a first magnet 4121 fixed to the top wall 4111, a second magnet 4122 fixed to the bottom wall 4112, and a pole core 4123 sandwiched between the first magnet 4121 and the second magnet 4122. The first magnet 4121 and the second magnet 4122 each are magnetized along the direction of the optical axis X, and a magnetizing direction of the first magnet 4121 is opposite to a magnetizing direction of the second magnet 4122.

The coil 42 includes a first coil wall 421 and a second coil wall 422 opposite to each other in parallel, and a pair of third coil walls 423 connecting the first coil wall 421 to the second coil wall 422. The first coil wall 421 is closer to the lens barrel 20 than the second coil wall 422. A length d1 of an orthographic projection of the first coil wall 421 along the direction of the optical axis X is greater than a length d2 of an orthographic projection of the second coil wall 422 along the direction of the optical axis X. When viewed along the direction of the optical axis X, the coil 42 and the magnet portion 412 have contour shapes matching each other.

The pair of support arms 21 are fixedly connected to the pair of third coil walls 423.

In an embodiment of the present disclosure, the elastic connection member 30 is made of a polymer material. The polymer material includes at least one of silica gel, nitrile rubber, ethylene acrylate rubber, acrylate rubber, butyl rubber, polyether-ether-ketone plastic and polyimide plastic. It is understandable that, the elastic connection member 30 may also be a metal spring piece.

The elastic connection member 30 includes a first elastic member 31 arranged at a top of the lens barrel 20 and a second elastic member 32 arranged at a bottom of the lens barrel 20. The first elastic member 31 is of a complete annular structure. Four second elastic members 32 are correspondingly arranged at four corners 101 of the fixation frame 10.

The elastic connection member 30 includes a deformation portion 301 having a wave-shaped cross section, a first fixing portion 302 extending from an inner periphery of the deformation portion 301, and a second fixing portion 303 extending from an outer periphery of the deformation portion 301. The first fixing portion 302 is fixed to the lens barrel 20, and the second fixing portion 303 is fixed to the fixation frame 10.

In the lens driving device of the embodiments of the present disclosure, the driving assembly is arranged at the corner of the fixation frame. The magnetic frame includes the top wall, the bottom wall and the side wall. The magnet portion is sandwiched between the top wall and the bottom wall, and the coil is arranged at a peripheral of the magnet portion. The lens barrel extends towards the coil to form a pair of support arms for clamping the coil, and the pair of support arms enter the magnetic frame from the two notches of the side wall to clamp the coil. The lens driving device of the embodiments of the present disclosure cleverly configure the position and the structure of the driving assembly, and configure the magnetic frame and the magnet portion to form a closed magnetic circuit system, which can significantly reduce magnetic leakage. On one hand, the power conversion efficiency is improved. When the driving assembly provides a same driving force, a volume of the driving assembly can be smaller, which can provide more design choices for other components; or when the driving assembly has a same volume, the driving assembly can provide a greater driving force, and can improve the driving sensitivity. On the other hand, magnetic interference caused by the driving assembly to other ferromagnetic components and electronic elements can be reduced.

The above description merely describes some of, rather than all of embodiments of the present disclosure, and it can be understood that those skilled in the art can further make improvements without departing from a concept of the present disclosure, but all of these improvements shall fall within a scope of the present disclosure.

What is claimed is:

1. A lens driving device, comprising:
a fixation frame;
a lens barrel received in the fixation frame and configured to carry a lens assembly having an optical axis;
an elastic connection member connecting the fixation frame to the lens barrel and supporting the lens barrel to move relative to the fixation frame; and
a driving assembly driving the lens barrel to move along a direction of the optical axis,
wherein the driving assembly is arranged at a corner of the fixation frame, the driving assembly comprises a magnetic circuit system fixed to the fixation frame and a coil fixed to the lens barrel, the magnetic circuit system comprises a magnetic frame and a magnet portion received in the magnetic frame, the magnetic frame comprises a top wall and a bottom wall opposite to each other along the direction of the optical axis, and a side wall connecting the top wall and the bottom wall, the magnet portion is sandwiched between the top wall and the bottom wall, the coil is received in the magnetic frame and arranged at a peripheral of the magnet portion, the side wall is provided with two notches that are formed at two sides of the coil, the lens barrel extends toward the coil to form a pair of support arms for clamping the coil, and the pair of support arms enter the magnetic frame from the two notches of the side wall to clamp the coil.

2. The lens driving device as described in claim 1, wherein the magnet portion comprises a first magnet fixed to the top wall, a second magnet fixed to the bottom wall, and a pole core sandwiched between the first magnet and the second magnet; the first magnet and the second magnet are magnetized in the direction of the optical axis; and a magnetizing direction of the first magnet is opposite to a magnetizing direction of the second magnet.

3. The lens driving device as described in claim 1, wherein the coil comprises a first coil wall and a second coil wall opposite to each other in parallel, and a pair of third coil walls connecting the first coil wall to the second coil wall; the first coil wall is closer to the lens barrel than the second coil wall; a length of an orthographic projection of the first coil wall along the direction of the optical axis is greater than a length of an orthographic projection of the second coil wall along the direction of the optical axis; and the pair of support arms are fixedly connected to the pair of third coil walls.

4. The lens driving device as described in claim 1, wherein when viewed from the direction of the optical axis, the coil and the magnet portion have contour shapes matching each other.

5. The lens driving device as described in claim 1, wherein two driving assemblies are provided, and the two driving assemblies are arranged at a pair of corners opposite to each other of the fixation frame.

6. The lens driving device as described in claim 1, wherein the elastic connection member is made of a polymer material.

7. The lens driving device as described in claim 6, wherein the polymer material comprises at least one of silica gel, nitrile rubber, ethylene acrylate rubber, acrylate rubber, butyl rubber, polyether-ether-ketone plastic or polyimide plastic.

8. The lens driving device as described in claim 6, wherein the elastic connection member comprises:
a first elastic member that is arranged at a top of the lens barrel and is of a complete annular structure; and
four second elastic members that are arranged at a bottom of the lens barrel and correspondingly arranged at four corners of the fixation frame.

9. The lens driving device as described in claim 6, wherein the elastic connection member comprises a deformation portion having a wave-shaped cross section, a first fixing portion extending from an inner periphery of the deformation portion, and a second fixing portion extending from an outer periphery of the deformation portion; and the first fixing portion is fixed to the lens barrel, and the second fixing portion is fixed to the fixation frame.
